(19) United States
(12) Patent Application Publication
(10) Pub. No.: US 2007/0052909 A1
(43) Pub. Date: Mar. 8, 2007

(54) Liquid crystal display panel and fabricating method thereof

(76) Inventors: Chih-Chien Chou, Sijhih City (TW); Fu-Kuo Ou, Hsinchu City (TW)

Correspondence Address: J C PATENTS, INC., 4 VENTURE, SUITE 250, IRVINE, CA, 92618, US

(21) Appl. No.: 11/220,787

(22) Filed: Sep. 6, 2005

(51) Int. Cl. G02F 1/1339

(52) U.S. Cl. 349/155

(57) ABSTRACT

A liquid crystal display panel and a fabricating method thereof are provided. The method of fabricating the liquid crystal display panel includes providing an active device array substrate and an opposite substrate. A common voltage input circuit is disposed on the active device array substrate and a common electrode layer is disposed on the opposite substrate. Then, a plurality of conductive posts are formed on the common voltage input circuit or the common electrode layer. Thereafter, a sealant and a liquid crystal layer are disposed between the active device array substrate and the opposite substrate. The sealant encloses the liquid crystal layer. The conductive posts are embedded inside the sealant and electrically connected to the common voltage input circuit and the common electrode layer. Furthermore, a gap is kept between the active device array substrate and the opposite substrate by the conductive posts.

### BACKGROUND OF THE INVENTION

1. Field of the Invention

The present invention relates to a display panel and fabricating method thereof. More particularly, the present invention relates to a liquid crystal display panel and fabricating method thereof.

2. Description of the Related Art

With the development of opto-electronic and semiconductor fabrication technology in recent years, flat panel displays are proliferating at a tremendous pace. Among various types of flat panel displays, liquid crystal displays, with operating advantages including low operating voltage and radiation-free operation, light weight, compact size and small volume, have gradually replaced the cathode ray tubes (CRT) as one of the mainstream display products.

FIG. 1 is a schematic cross-sectional view of a conventional liquid crystal display panel. As shown in FIG. 1, a conventional liquid crystal display 100 comprises a thin film transistor array substrate 110, a color filtering substrate 120, a sealant 130, a liquid crystal layer 140 and a conductive element 150. The sealant 130 is disposed between the color filtering substrate 120 and the thin film transistor array substrate 110. The liquid crystal layer 140 is enclosed by the color filtering substrate 120, the thin film transistor array substrate 100 and the sealant 130. Furthermore, a common voltage input circuit 112 is disposed on the peripheral region of the thin film transistor array substrate 110 and a common electrode layer 122 is disposed on the color filtering substrate 120.

To provide the common electrode layer 122 with a common voltage from the common voltage input circuit 112, the common electrode layer 122 and the common voltage input circuit 112 are electrically connected through the conductive element 150 in the conventional technology. However, this type of electrical connection often leads to increased dimension of the liquid crystal display panel 100 so that the space necessary for accommodating the conductive element 150 is provided outside the sealant 130 and the liquid crystal layer 140.

### SUMMARY OF THE INVENTION

Accordingly, at least one objective of the present invention is to provide a liquid crystal display panel suitable for reducing the non-display area of the liquid crystal display panel.

At least a second objective of the present invention is to provide a method of fabricating a liquid crystal display panel suitable for reducing the production cost of the liquid crystal display panel.

To achieve these and other advantages and in accordance with the purpose of the invention, as embodied and broadly described herein, the invention provides a liquid crystal display panel. The liquid crystal display panel comprises an active device array substrate, a common voltage input circuit, an opposite substrate, a common electrode layer, a liquid crystal layer, a sealant and a plurality of conductive posts. The common voltage input circuit is disposed on the active device array substrate and the common electrode layer is disposed on the opposite substrate. The sealant and the liquid crystal layer are disposed between the active device array substrate and the opposite substrate such that the sealant encloses the liquid crystal layer. The conductive posts are disposed between the common voltage input circuit and the common electrode layer inside the sealant and electrically connected to the common voltage input circuit and the common electrode layer. Furthermore, a gap is kept between the active device array substrate and the opposite substrate by the conductive posts.

In the aforementioned liquid crystal panel, the conductive posts can be solid metallic blocks fabricated using aluminum, copper or tungsten, for example.

Alternatively, each conductive post includes a core block and a conductive outer layer. The conductive outer layer encloses the core block and electrically connects with the common voltage input circuit and the common electrode layer. The conductive outer layer is fabricated using aluminum, copper or tungsten and the core block is fabricated using resin, for example.

The present invention also provides a method of fabricating a liquid crystal display panel. First, an active device array substrate and an opposite substrate are provided. A common voltage input circuit is disposed on the active device array substrate and a common electrode layer is disposed on the opposite substrate. Then, a plurality of conductive posts are formed on the common voltage input circuit or the common electrode layer. Thereafter, a sealant and a liquid crystal layer are disposed between the active device array substrate and the opposite substrate. The sealant encloses the liquid crystal layer. The conductive posts are disposed inside the sealant and electrically connected to the common voltage input circuit and the common electrode layer. Furthermore, a gap is kept between the active device array substrate and the opposite substrate by the conductive posts.

In fabricating the liquid crystal display panel, the method of forming the conductive posts includes forming a patterned photoresist layer on the common voltage input circuit or the common electrode layer. The patterned photoresist layer has a plurality of openings. Then, conductive posts are formed inside the openings. Finally, the patterned photoresist layer is removed. In addition, the method of forming the conductive posts inside the openings includes performing an electroless plating process, for example.

In fabricating the liquid crystal display panel, the method of forming the conductive posts may also include forming a conductive layer on the common voltage input circuit or the common electrode layer and patterning the conductive layer into conductive posts thereafter.

In fabricating the liquid crystal display panel, the method of forming the conductive posts may also include forming a plurality of core blocks on the common voltage input circuit or the common electrode layer and forming a conductive outer layer on each core block thereafter. The method of forming the core blocks includes depositing a core material layer on the common voltage input circuit or the common electrode layer to form a core material layer and patterning the core material layer into core blocks thereafter. The method of forming the conductive outer layer includes forming a conductive layer on the common voltage input circuit or the common electrode layer to cover the core blocks and patterning the conductive layer to form conductive outer layers on various core blocks.

In brief, the liquid crystal display panel and manufacturing method thereof according to the present invention combines the conductive posts and the sealant together in one location so that the non-display area of the liquid crystal display panel can be reduced. With reduced overall dimension of the liquid crystal display panel, the production cost of the liquid crystal display panel can also be lowered.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic local cross-sectional view of a conventional liquid crystal display panel.

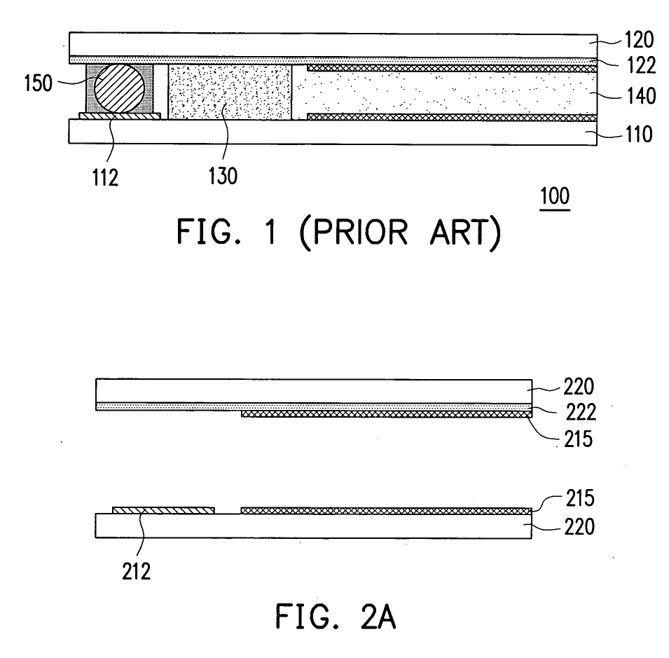

FIGS. 2A to 2C are schematic cross-sectional views showing the steps for fabricating a liquid crystal display panel according to one embodiment of the present invention.

FIGS. 3 and 4 show two methods in the step shown in FIG. 2B for producing the conductive posts.

FIG. 5 is a local cross-sectional view of a liquid crystal display panel according to another embodiment of the present invention.

FIGS. 6A to 6C are schematic cross-sectional views showing the steps for fabricating the conductive posts of the liquid crystal display panel shown in FIG. 5.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

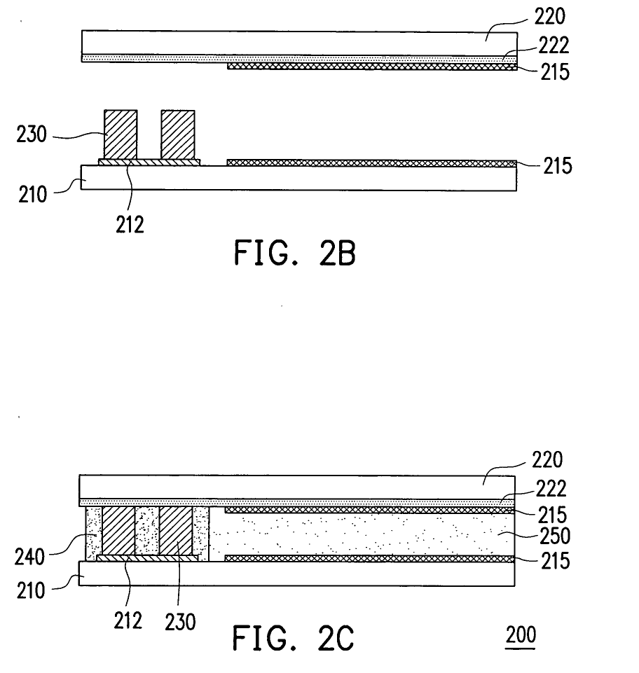

FIGS. 2A to 2C are schematic cross-sectional views showing the steps for fabricating a liquid crystal display panel according to one embodiment of the present invention. In FIGS. 2A through 2C, only the peripheral portion of the liquid crystal display panel is shown. First, as shown in FIG. 2A, the method of fabricating the liquid crystal display panel according to the present embodiment includes providing an active device array substrate 210 and an opposite substrate 220. A common voltage input circuit 212 is disposed on the active device array substrate 210 and a common electrode layer 222 is disposed on the opposite substrate 220. In addition, an alignment layer 215 is also formed on the active device array substrate 210 and the opposite substrate 220, for example.

As shown in FIG. 2B, a plurality of conductive posts 230 are formed on the common voltage input circuit 212 or the common electrode layer 222. In FIG. 2B, the conductive posts 230 are formed on the common voltage input circuit 212 as an example. However, the conductive posts 230 may also be formed on the common electrode layer 222. Furthermore, two conductive posts 230 are shown in the cross-sectional direction in FIG. 2B as an example. In practice, there is no particular restriction on the number of conductive posts 230 that can be laid down in the cross-sectional direction. The number of conductive posts 230 deployed can be modified according to the actual demand. In the following, the method of forming the conductive posts 230 will be explained in more detail.

As shown in FIG. 2C, a sealant 240 and a liquid crystal layer 250 are disposed between the active device array substrate 210 and the opposite substrate 220. The sealant 240 encloses the liquid crystal layer 250 and the liquid crystal layer 250 is sealed between the active device array substrate 210 and the opposite substrate 220. In addition, the conductive posts 240 are embedded inside the sealant 240 and are electrically connected to the common voltage input circuit 212 and the common electrode layer 222. In other words, the sealant 240 covers a portion of the common voltage input circuit 212. Moreover, a gap is kept between the active device array substrate 210 and the opposite substrate 220 by the conductive posts 230. In general, the size of the gap varies according to the design requirement. Up to this point, the major steps for assembling the liquid crystal display panel 200 are mostly completed.

Furthermore, the step of disposing the sealant 240 and the liquid crystal layer 250 includes, for example, positioning the sealant 240 on the active device array substrate 210 or the opposite substrate 220. The conductive posts 230 and the sealant 240 may be disposed on the same substrate or on two different substrates. Then, the active device array substrate 210 and the opposite substrate 220 are joined together so that the common voltage input circuit 212 and the common electrode layer 222 are electrically connected through the conductive posts 230. Thereafter, liquid crystal is injected into the space between the active device array substrate 210 and the opposite substrate 220 to form the liquid crystal layer 250. The sealant 240 encloses the liquid crystal layer 250 and prevents it from leaking. Alternatively, after disposing the sealant 240 on the active device array substrate 210 or the opposite substrate 220, liquid crystal is dropped into the area enclosed by the sealant 240. Then, the active device array substrate 210 and the opposite substrate 220 are joined together.

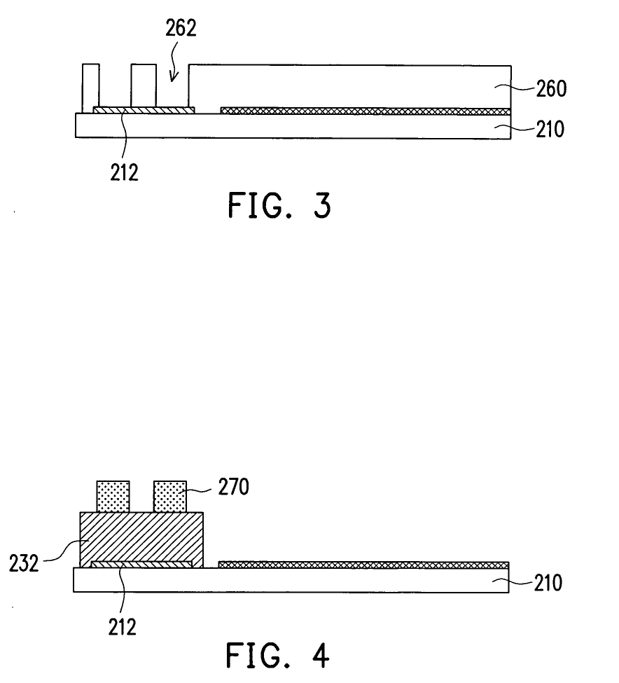

FIGS. 3 and 4 show two methods in the step shown in FIG. 2B for producing the conductive posts. As shown in FIGS. 2B and 3, the method of forming the conductive posts 230 includes, for example, forming a patterned photoresist layer 260 on the common voltage input circuit 212. The patterned photoresist layer 260 has a plurality of openings 262 formed by performing a photo-exposure and a development process, for example. Thereafter, the conductive posts 230 are formed inside the openings 262, for example, by performing an electroless plating operation or some other suitable process for filling conductive material into the openings 262. Lastly, the patterned photoresist layer 260 is removed to complete the process of fabricating the conductive posts 230. Furthermore, if the conductive posts 230 are formed on the common electrode layer 222, the aforementioned steps are carried out on the common electrode layer 222.

As shown in FIGS. 2B and 4, the method of forming the conductive posts 230 may also include forming a conductive layer 232 on the common voltage input circuit 212 and patterning the conductive layer 232 to form the conductive posts 230 thereafter. The conductive layer 232 is formed, for example, by performing a photolithographic process to form a patterned photoresist layer 270 on the conductive layer 232, etching the conductive layer 232 using the patterned photoresist layer 270 as an etching mask and finally removing the patterned photoresist layer 270.

As shown in FIG. 2C, a liquid crystal display panel 200 in one embodiment of the present invention comprises an active device array substrate 210, a common voltage input circuit 212, an opposite substrate 220, a common electrode layer 222, a liquid crystal layer 250, a sealant 240 and a plurality of conductive posts 230. The common voltage input circuit 212 is disposed on the active device array substrate 210 and the common electrode layer 222 is disposed on the opposite substrate 220. The liquid crystal layer 250 and the sealant 240 are disposed between the active device array substrate 210 and the opposite substrate 220 with the sealant 240 enclosing the liquid crystal layer 250. The conductive posts 230 are disposed between the common voltage input circuit 212 and the common electrode layer 222 inside the sealant 240. The conductive posts 230 electrically connect with the common voltage input circuit 212 and the common electrode layer 222 and keeps a gap between the active device array substrate 210 and the opposite substrate 220.

In addition, the conductive posts 230 in the present embodiment are solid metallic blocks fabricated from aluminum, copper, tungsten or other suitable metal, for example. The active device array substrate 210 is a thin film transistor array substrate or other active device array substrate, for example. More specifically, the active device array substrate 210 can be a high-temperature polysilicon thin film transistor array substrate. The active device array substrate 210 can be categorized, according to the material constituting the substrate, into one comprising a silicon substrate (not shown) and an active device array (not shown) on top or another comprising a glass substrate (not shown) and an active device array (not shown) on top. Obviously, other suitable materials can be selected to form the substrate of the active device array substrate 210. Furthermore, the opposite substrate 220 can be a color filtering substrate with a color filtering film thereon.

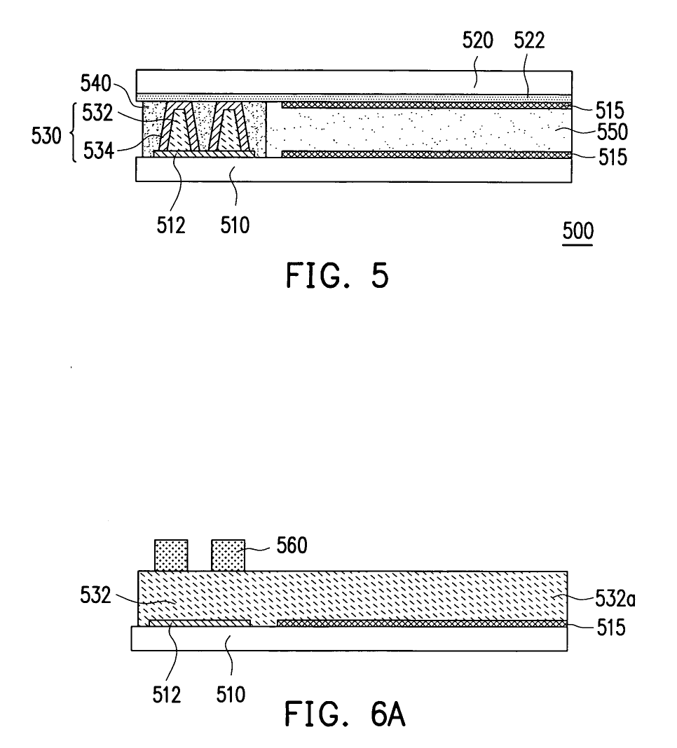

FIG. 5 is a local cross-sectional view of a liquid crystal display panel according to another embodiment of the present invention. As shown in FIG. 5, the liquid crystal display panel 500 in the present embodiment is almost identical to the liquid crystal display panel 200 shown in FIG. 2C. Similar components are labeled identically and a detailed description of these parts is omitted. One major difference between the liquid crystal display panel 500 and the liquid crystal display panel 200 in FIG. 2C is that each conductive post 530 comprises a core block 532 and a conductive outer layer 534. The conductive outer layer 534 encloses the core block 532 and electrically connects with the common voltage input circuit 512 and the common electrode layer 522. The conductive outer layer 534 is fabricated using aluminum, copper, tungsten or other suitable metal, for example. The core blocks 532 can be fabricated using a conductive material or a non-conductive material such as resin.

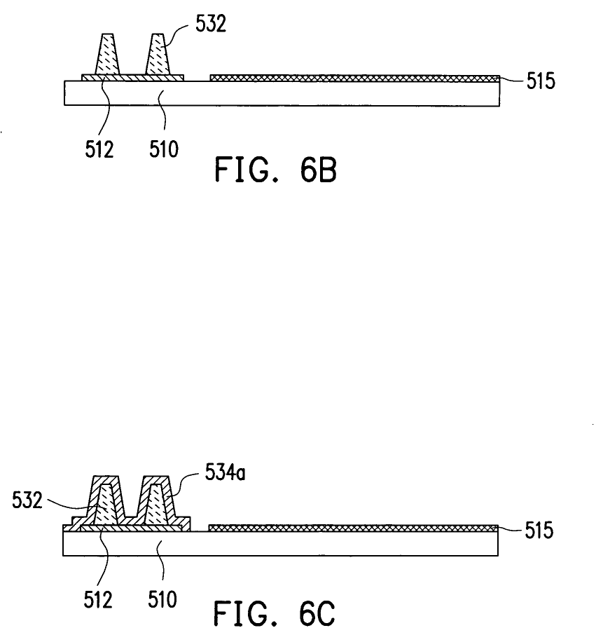

FIGS. 6A to 6C are schematic cross-sectional views showing the steps for fabricating the conductive posts of the liquid crystal display panel shown in FIG. 5. First, as shown in FIG. 6A, a core material layer 532a (formed on the common voltage input circuit 512 in the present embodiment) is formed on the common voltage input circuit 512 or the common electrode layer 522. Then, as shown in FIG. 6B, the core material layer 532a is patterned to form the core blocks 532. The method of patterning the core material layer 532a includes performing photolithographic and etching processes to form a patterned photoresist layer 560 on the core material layer 532a and patterning the core material layer 532a using the patterned photoresist layer 560 as a mask. Thereafter, as shown in FIG. 6C, a conductive layer 534a is formed on the common voltage input circuit 512 to cover the core blocks 532 and patterning the conductive layer 534a to form the conductive outer layer 534 outside the core blocks 532 as shown in FIG. 5. The conductive layer 534a can be patterned through the method for patterning the core material layer 532a.

In summary, the liquid crystal display panel and fabricating method thereof in the present invention positions the conductive posts and the sealant in the same location. Hence, there is no need to reserve space outside the sealant for connecting electrically with the common voltage input circuit and the common electrode layer as in the conventional fabricating technology so that the non-display area in the liquid crystal display panel can be reduced. With reduced size of the non-display area in the liquid crystal display panel, the number of substrate that can be cut out from a single motherboard in the substrate fabrication process can be increased. Therefore, the processing time as well as the production cost can be reduced. Furthermore, the conductive posts can be fabricated using a semiconductor process so that the fabrication of the conductive posts can be integrated with the fabrication of the active device array substrate or the opposite substrate to shorten the subsequent process of joining the substrates together and save additional production cost. Moreover, using the semiconductor process to fabricate the conductive posts also confers additional advantages including better alignment accuracy of the posts, the capacity to form smaller conductive posts and a better control on the height of the conductive posts. Ultimately, product yield is increased and precise cell gaps are obtained.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display panel, comprising:
an active device array substrate;
a common voltage input circuit disposed on the active device array substrate;
an opposite substrate;
a common electrode layer disposed on the opposite substrate;
a liquid crystal layer disposed between the active device array substrate and the opposite substrate;
a sealant disposed between the active device array substrate and the opposite substrate and enclosing the liquid crystal layer; and
a plurality of conductive posts disposed between the common voltage input circuit and the common electrode layer inside the sealant for electrically connecting with the common voltage input circuit and the common electrode layer so that a gap is kept between the active device array substrate and the opposite substrate.

2. The liquid crystal display panel of claim 1, wherein the conductive posts are solid metallic blocks.

3. The liquid crystal display panel of claim 2, wherein the material forming the conductive posts comprises aluminum, copper or tungsten.

4. The liquid crystal display panel of claim 1, wherein each conductive post comprises:
a core block; and
a conductive outer layer enclosing the core block and electrically connecting with the common voltage input circuit and the common electrode layer.

5. The liquid crystal display panel of claim 4, wherein the material forming the conductive outer layer includes aluminum, copper or tungsten.

6. The liquid crystal display panel of claim 4, wherein the material constituting the core blocks includes resin.

7. A method of fabricating a liquid crystal display panel, comprising:
providing an active device array substrate and an opposite substrate, wherein a common voltage input circuit is disposed on the active device array substrate and a common electrode layer is disposed on the opposite substrate;
forming a plurality of conductive posts on the common voltage input circuit or the common electrode layer;
disposing a sealant and a liquid crystal layer between the active device array substrate and the opposite substrate such that the sealant encloses the liquid crystal layer, wherein the conductive posts are embedded inside the sealant and electrically connected to the common voltage input circuit and the common electrode layer, and a gap is kept between the active device array substrate and the opposite substrate by the conductive posts.

8. The method of claim 7, wherein the step of forming the conductive posts comprises:
forming a patterned photoresist layer on the common voltage input circuit or the common electrode layer, wherein the patterned photoresist layer has a plurality of openings;
forming the conductive posts inside the respective openings; and
removing the patterned photoresist layer.

9. The method of claim 8, wherein the step of forming the conductive posts inside the openings includes performing an electroless plating operation.

10. The method of claim 7, wherein the step of forming the conductive posts comprises:
forming a conductive layer on the common voltage input circuit or the common electrode layer; and
patterning the conductive layer to form the conductive posts.

11. The method of claim 7, wherein the step of forming the conductive posts comprises:
forming a plurality of core blocks on the common voltage input circuit or the common electrode layer; and
forming a conductive outer layer to cover each core block.

12. The method of claim 11, wherein the step of forming the core blocks comprises:
forming a core material layer on the common voltage input circuit or the common electrode layer; and
patterning the core material layer to form the core blocks.

13. The method of claim 11, wherein the step of forming the conductive outer layer comprises:
forming a conductive layer on the common voltage input circuit or the common electrode layer, wherein the conductive layer covers the core blocks; and
patterning the conductive layer to form the conductive outer layer covering the core blocks.
